(19) United States
(12) Patent Application Publication
(10) Pub. No.: US 2025/0368269 A1
(43) Pub. Date: Dec. 4, 2025

(54) LIGHTWEIGHT PANEL FOR A VEHICLE AND A METHOD OF MANUFACTURING THE SAME

(71) Applicants: HYUNDAI MOTOR COMPANY, Seoul (KR); KIA CORPORATION, Seoul (KR); DAESOL AUSYS CO.,LTD, Incheon (KR)

(72) Inventors: Jung-Jong Chun, Hwaseong-si (KR); Ji-Yun Ha, Hwaseong-si (KR); Min-Soo Kim, Hwaseong-si (KR); Joon-Chul Park, Hwaseong-si (KR); Chae-Wook Lee, Hwaseong-si (KR); Seung-Hu Cho, Siheung-si (KR); Jae-Kwan Ko, Seoul (KR); Min-Ho Kwon, Seoul (KR); Jae-Kyun Namgung, Incheon (KR)

(73) Assignees: HYUNDAI MOTOR COMPANY, Seoul (KR); KIA CORPORATION, Seoul (KR); DAESOL AUSYS CO.,LTD, Incheon (KR)

(21) Appl. No.: 18/962,748

(22) Filed: Nov. 27, 2024

(30) Foreign Application Priority Data
Jun. 3, 2024 (KR) 10-2024-0072392

(51) Int. Cl. B62D 25/06; B29C 70/46; B32B 3/12; B32B 3/26; B32B 27/10; B62D 29/04

(52) U.S. Cl. CPC B62D 25/06; B29C 70/46; B32B 3/12; B32B 3/263; B32B 27/10; B62D 29/043; B32B 2250/03; B32B 2250/40; B32B 2605/00

(57) ABSTRACT

A lightweight panel for a vehicle includes a honeycomb part having a paper honeycomb whose interior is formed in a honeycomb structure and is machined to a predetermined thickness, a reinforcing layer including a reinforcing mat and a reinforcing resin, formed on each of upper and lower surfaces of the honeycomb part, and a plurality of concave portions formed in a lower surface of the honeycomb part.

### CROSS-REFERENCE TO RELATED APPLICATION

This application claims priority to Korean Patent Application No. 10-2024-0072392, filed on Jun. 3, 2024, which is incorporated herein by reference in its entirety.

### BACKGROUND

### Field of the Disclosure

The present disclosure relates to a lightweight panel for a vehicle to which a lightweight honeycomb structure is applied, and more specifically, to a lightweight panel for a vehicle and a method of manufacturing the same.

### Description of Related Art

Various types of panels 120 are used in vehicles to partition an internal space of the vehicle or form an exterior of the vehicle.

For example, FIG. 1 shows a luggage board as an example of a panel 120. The luggage board may be used to separate a cabin and loading space of the vehicle.

A cross section of the panel 120 has a structure as shown in FIG. 2. A honeycomb part 121 is formed by processing a paper honeycomb P. A reinforcing layer 123 is formed on upper and lower surfaces of the honeycomb part 121 by spraying polyurethane on to a fiberglass (e.g., glass fiber) mat when the fiberglass mat is fixed to each of the upper and lower surfaces of the honeycomb part 121. The reinforcing layer 123 is formed by impregnating, saturating, or infusing the fiberglass mat with the polyurethane. A portion of the polyurethane is impregnated, saturated, or infused into the honeycomb part 121 to form an impregnation layer 122 (e.g., saturated layer 122, partially saturated layer 122, infused layer 122).

The paper honeycomb P, which becomes the honeycomb part 121, may include hexagonal pillars, which are continuously formed without any gap, as shown in an enlarged view of FIG. 2. The continuously formed hexagonal pillars may exhibit rigidity. The paper honeycomb P may be lightweight due to being formed of a paper material. In particular, the fiberglass mat (e.g., glass fiber mat) forms the reinforcing layer 123 through the polyurethane on the upper and lower surfaces of the honeycomb part 121, thereby further increasing rigidity.

When the reinforcing layer 123 and the impregnation layer 122 are formed on the honeycomb part 121, a desired shape is manufactured using a thermoforming mold.

Thereafter, when the panel 120, for example, a luggage board, is mounted on the vehicle, a skin layer 124 is formed by surrounding a lower surface which is not visible (e.g., from an interior of the vehicle) with non-woven fabric 125 and surrounding a visible upper surface with carpet.

However, the panel 120 in the related art has a problem that an area or portion of a vehicle to which the panel may be applied is unavoidably limited to a luggage board, etc. as the overall thickness of the honeycomb part 121 is constantly formed.

In addition, since the panel 120 is formed only in a constant thickness, a portion to which the panel 120 may be applied is unavoidably limited.

In addition, since surfaces, for example, upper and lower surfaces of the panel 120 are formed to be flat, a shape of the panel 120 is simple, and it is difficult to secure a space for additionally mounting other devices.

### SUMMARY

The present disclosure is provided to solve the above mentioned problems and is directed to a lightweight panel for a vehicle, in which a lightweight honeycomb structure is used therein, an edge is formed by bending a perimeter of a panel, and a concave portion is formed on a lower surface.

To achieve these objects, according to the present disclosure, there is provided a lightweight panel. The lightweight panel includes: a honeycomb part having a paper honeycomb whose interior is formed in a honeycomb structure is machined to a predetermined thickness; and a reinforcing layer including a reinforcing mat and a reinforcing resin and formed on each of upper and lower surfaces of the honeycomb part. The lightweight panel further includes a plurality of concave portions formed in a lower surface of the honeycomb part.

The plurality of concave portions are formed by milling the paper honeycomb into the honeycomb part and then thermally molding the honeycomb part.

The concave portion is machined to a size smaller than a target size of the concave portion during milling, and molded to the target size during thermal molding.

The concave portion is machined to be smaller in a width direction of the vehicle than in a longitudinal direction of the vehicle during the milling machining.

The size of the concave portion machined in the milling machining and the target size of the concave portion are machined to have a difference in the width direction of the vehicle that is 1.8 to 2.2 times larger than a difference in the longitudinal direction of the vehicle.

The panel has an edge formed by being bent in a longitudinal direction or width direction of the vehicle along a perimeter of the honeycomb part.

The edge includes a first edge bent in the longitudinal direction of the vehicle with respect to the width direction of the vehicle, and a second edge bent in the width direction of the vehicle with respect to the longitudinal direction of the vehicle.

One of the first edge and the second edge is formed by forming a V-shaped notch whose cross section is formed in a V shape on the paper honeycomb and bonding the paper honeycomb along the V-shaped notch during thermal molding.

The other of the first edge and the second edge is formed by bending the concave portion during thermal molding that machines the concave portion to the target size.

A triangular notch is formed on a portion of the honeycomb part where the edges are folded, and the two edges are in contact with each other by being bent at the triangular notch.

Meanwhile, a method of manufacturing a lightweight panel for a vehicle, which includes a honeycomb part having a paper honeycomb whose interior is formed in a honeycomb structure and is machined to a predetermined thickness, and a reinforcing layer including a reinforcing mat and a reinforcing resin, formed on each of upper and lower surfaces of the honeycomb part, includes a forming a honeycomb part by machining the paper honeycomb to a predetermined thickness and forming a concave portion in the honeycomb part, during a honeycomb machining operation. The method also includes forming a V-shaped notch on the honeycomb part during a notch forming operation and thermally molding the honeycomb part to a predetermined shape during a thermal molding operation.

In the honeycomb part machining operation, the concave portion is machined to a size smaller than a target size of the concave portion, and molded to the target size in the thermal molding operation.

In the honeycomb part machining operation, the concave portion is machined to be smaller in a width direction of the vehicle than in a longitudinal direction of the vehicle.

The size of the concave portion machined in the honeycomb part machining operation and the target size of the concave portion have a difference in the width direction of the vehicle that is 1.8 to 2.2 times larger than a difference in the longitudinal direction of the vehicle.

In the notch forming operation, the V-shaped notch is formed in a direction perpendicular to a bonding line of the paper honeycomb, which bonds pieces of paper with unevenness.

In the thermal molding operation, the honeycomb part forms a second edge by being bent about the V-shaped notch.

In the thermal molding operation, the honeycomb part forms a first edge by being bent in a direction perpendicular to a direction in which the V-shaped notch is formed.

The notch forming operation includes forming a triangular notch on a portion where the first edge meets the second edge.

The method further includes a mat fixing operation between the honeycomb part machining operation and the notch forming operation, the mat fixing operation including fixing a mat to each of upper and lower surfaces of the honeycomb part and bonding the mat to the honeycomb part by applying a resin to the mat and the honeycomb part.

The method further includes a trimming operation of cutting an unnecessary scrap of a perimeter of the honeycomb part after the thermal molding operation.

According to the lightweight panel for a vehicle and the method of manufacturing the same of the present disclosure, by manufacturing the panel for a vehicle using the lightweight paper honeycomb, it is possible to make the vehicle lightweight, and the user can easily handle the panel.

In addition, the size of the concave portion can be formed through multiple machining operations so that the concave portion may be precisely machined to the target size.

In addition, by bending the edge after forming the V-shaped notch in the direction of not being easily bent, the bent edge can be easily formed along the perimeter of the panel member.

### BRIEF DESCRIPTION OF THE DRAWINGS

FIG. 1 is a perspective view of a luggage board according to an example of a panel member in the related art.

FIG. 2 is a cross-sectional view along line I-I in FIG. 1.

FIG. 3 is a perspective view of a vehicle to which a lightweight panel for a vehicle according to the present disclosure is applied.

FIG. 4 is a perspective view showing a roof panel detached from the vehicle to which the lightweight panel for a vehicle according to the present disclosure is applied.

FIG. 5 is a plan view showing a state of milling a paper honeycomb to manufacture the lightweight panel for a vehicle according to the present disclosure.

FIG. 6 is a plan view showing a state of thermally molding the paper honeycomb in the lightweight panel for a vehicle according to the present disclosure.

FIG. 7 is a schematic view showing a process of thermally molding the paper honeycomb in the lightweight panel for a vehicle according to the present disclosure.

FIG. 8 is a cross-sectional view along line I-I in FIG. 5.

FIG. 9 is a cross-sectional view along line II-II in FIG. 6.

FIG. 10 is an enlarged view of portion A in FIG. 5.

FIG. 11 is an enlarged view of portion B in FIG. 6.

FIG. 12 is a cross-sectional view along line P1-P1 in FIG. 10.

FIG. 13 is a cross-sectional view along line P3-P3 in FIG. 11.

FIG. 14 is a cross-sectional view along line P2-P2 in FIG. 10.

FIG. 15 is a cross-sectional view along line P4-P4 in FIG. 11.

FIG. 16 is a plan view showing a state before bending in the method of manufacturing the lightweight panel for a vehicle according to the present disclosure.

FIG. 17 is a plan view of the lightweight panel for a vehicle according to the present disclosure.

FIG. 18 is a cross-sectional view along line III-III in FIG. 16.

FIG. 19 is a cross-sectional view along line IV-IV in FIG. 17.

FIG. 20 is an enlarged view of portion C in FIG. 16.

FIG. 21 is an enlarged perspective view of portion D in FIG. 17.

FIG. 22 is an exploded plan view of portion D in FIG. 17.

FIG. 23 is a flowchart showing a method of manufacturing the lightweight panel for a vehicle according to the present disclosure.

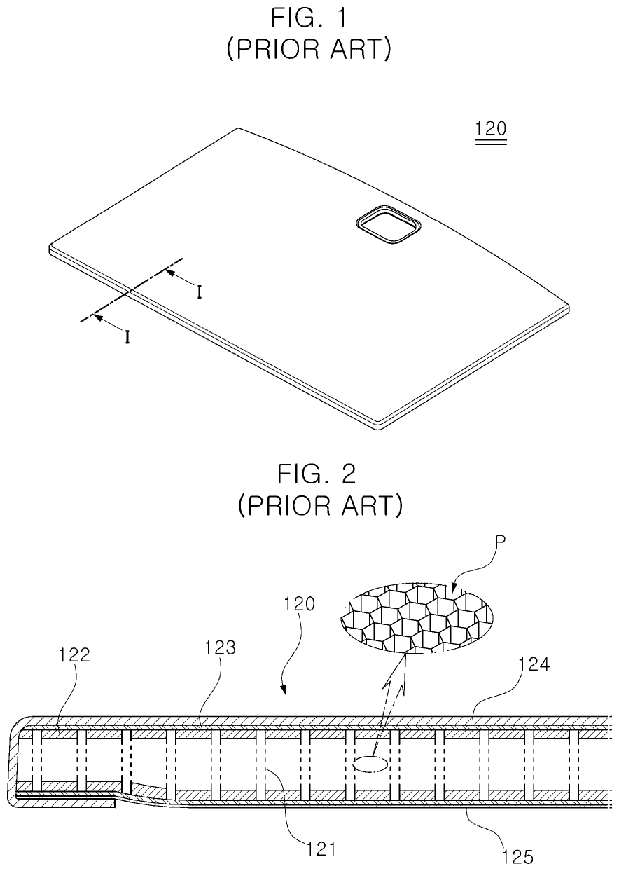

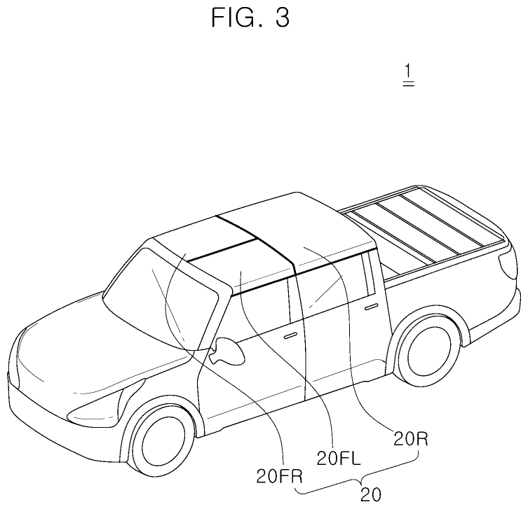

### DETAILED DESCRIPTION

Hereinafter, a lightweight panel for a vehicle and a method of manufacturing the lightweight panel for a vehicle according to the present disclosure are described in detail with reference to the accompanying drawings. When a component, device, element, or the like of the present disclosure is described as having a purpose or performing an operation, function, or the like, the component, device, or element or the like should be considered herein as being “configured to” meet that purpose or perform that operation or function.

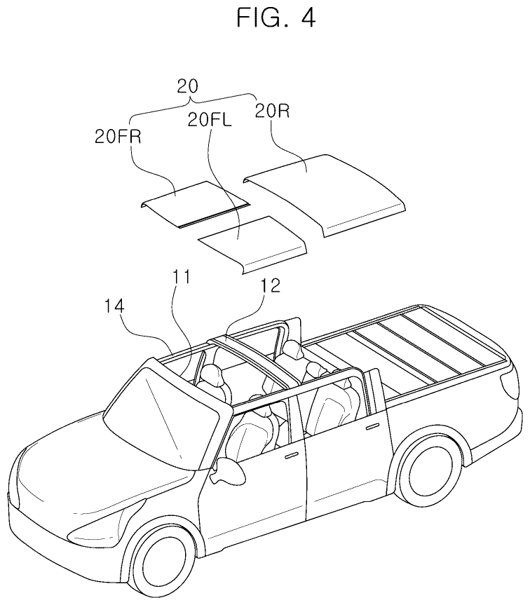

FIGS. 3 and 4 show an example in which a panel manufactured according to a method of manufacturing a lightweight panel for a vehicle according to the present disclosure is manufactured as a roof panel for a vehicle.

A roof panel 20 is detachably installed on the vehicle 1 to further expand the sense of openness perceived by a passenger of a vehicle in a limited traveling environment. Meanwhile, the panel may be used not only as the roof panel 20 in a vehicle, but also as exterior panels of a vehicle such as a hood, a tailgate, and a trunk lid.

A front rail 11 and a center rail 12 are formed on a roof of the vehicle 1 and may extend in a width direction of the vehicle 1. A roof side rail 14 is formed on or along side surfaces of the roof and my extend in a longitudinal direction of the vehicle 1. The roof panel 20 is mounted to the vehicle through the front rail 11, the center rail 12, and the roof side rail 13.

The roof panel 20 is configured by being partitioned into a plurality of subpanels. The subpanels include a front left roof panel 20FL, a front right roof panel 20FR, and a rear roof panel 20R.

A panel manufactured according to the method of manufacturing a lightweight panel for a vehicle according to the present disclosure has continuous hexagonal pillar structures therein and uses a paper honeycomb P made of paper. Thus, the panel is lightweight. As shown in FIGS. 3 and 4, the roof panel is mounted on a vehicle as a detachable roof panel, thereby allowing a user to easily handle the front left roof panel 20FL, the front right roof panel 20FR, and the rear roof panel 20R when attaching and detaching the front left roof panel 20FL, the front right roof panel 20FR, and the rear roof panel 20R.

The lightweight panel for a vehicle according to the present disclosure, which includes a honeycomb part 21 in which a paper honeycomb P whose interior is formed in a honeycomb structure is machined to a predetermined thickness, and a reinforcing layer formed of a reinforcing mat and a reinforcing resin and formed on each of upper and lower surfaces of the honeycomb part 21, further includes a plurality of concave forming parts or concave portions 25 formed in a lower surface of the honeycomb part 21.

The panel is manufactured by using the honeycomb part 21 formed by machining the paper honeycomb P to a predetermined thickness.

The paper honeycomb P includes repeated hexagonal column structures made of paper and has rigidity in a thickness direction of the paper honeycomb P. A portion of the paper honeycomb P machined into the panel is milled to a preset thickness to become the honeycomb part 21 of the panel. A portion of the paper honeycomb P that becomes the honeycomb part 21, for example, a portion excluding a perimeter, is machined to a predetermined thickness through milling. When the paper honeycomb P is milled to become the honeycomb part 21, the paper honeycomb P needs to be face-milled. Thus, the paper honeycomb P is milled into the honeycomb part 21 using a face cutter, etc.

In addition, the plurality of concave portions 25 are formed on the lower surface of the honeycomb part 21. The plurality of concave portions 25 are further machined to be concave from the honeycomb part 21. However, when the paper honeycomb P is machined into the honeycomb part 21, the concave portions 25 are not machined to a target size of the concave portions 25 and are instead machined to be smaller than the target size of the concave portions 25, and then machined to the target size during subsequent thermal molding.

In other words, when the paper honeycomb P is machined into the honeycomb part 21 through milling, the concave portions 25 are machined to be smaller than the target size of the concave portion 25. Thus, a width, length, and thickness of the concave portion 25 is machined to be smaller than the target size, and then secondary molding is performed so that the concave portion 25 becomes the target size during thermal molding.

For example, assuming that the target size of the concave portion 25 is W (width), L (length), and T (depth), after the paper honeycomb P has been milled into the honeycomb part 21, the size of the concave portion 25 becomes W′, L′, and T′ (here, W′<W, L′<L, T′<T).

During the milling, the concave portion 25 is machined to be smaller in a width direction of the vehicle 1 than in a longitudinal direction of the vehicle 1. In particular, the size of the concave portion 25 machined in the milling and the target size of the concave portion 25 are machined so that a difference in the width direction of the vehicle 1 is 1.8 to 2.2 times, for example, 2 times a difference in the longitudinal direction of the vehicle. The size of the concave portion 25 and the target size of the concave portion 25 are machined so that a difference in the width direction of the vehicle 1 is 2 times a difference in the longitudinal direction of the vehicle. For example, W′=W−10 mm, L′=L−5 mm, and T′=T−2 mm.

As described above, after the paper honeycomb P is machined into the honeycomb part 21, a mat is fixed to each of the upper and lower surfaces of the honeycomb part 21. Then, a resin is sprayed so that the mat is bonded to the paper honeycomb P by the resin. The mat may be a fiberglass (e.g., glass fiber) mat made of glass fiber, and the resin may be polyurethane.

The panel is formed with edges 26 and 27 that are bent along the perimeter thereof in the longitudinal or width direction of the vehicle 1.

The edges 26 and 27 may include a first edge 26 bent in the longitudinal direction of the vehicle 1 with respect to the width direction of the vehicle 1, and a second edge 27 bent in the width direction of the vehicle 1 with respect to the longitudinal direction of the vehicle 1.

The first edge 26 and the second edge 27 are formed by bending the perimeter of the honeycomb part 21 during thermal molding. Since the first edge 26 is bent in a direction in which the paper honeycomb P is not bent, the panel, which has been manufactured by forming a V-shaped notch 27a on the honeycomb part 21 and bending the honeycomb part 21 about the V-shaped notch 27a in order to form the first edge 26, shows a V-shaped notch line VL in which the V-shaped notch 27a is folded.

The second edge 27 is formed by bending during thermal molding. The panel, which has been completed along a line where the second edge 27 is bent, shows a bending line BL.

Meanwhile, by forming a triangular notch 27b on a portion where the first edge 26 meets the second edge 27, when thermal molding is finished, the first edge 26 meets the second edge 27.

The first edge 26 forms a rear end of the rear roof panel 20R of the roof panel 20 and is in contact with a rear end of a cabin. The second edge 27 becomes a left end of the front left roof panel 20FL, a right end of the front right roof panel 20FR, and both side ends of the rear roof panel 20R and is in contact with the roof side rail 13 of the vehicle 1.

According to an embodiment of the present disclosure, a method for manufacturing a lightweight panel is provided. The lightweight panel includes: the honeycomb part 21 having the paper honeycomb P whose interior is formed in the honeycomb structure and is machined to the predetermined thickness; and the reinforcing layer including the reinforcing mat and the reinforcing resin and formed on each of the upper and lower surfaces of the honeycomb part 21. The method includes a honeycomb part machining operation (S110) of forming the honeycomb part 21 by machining the paper honeycomb P to the predetermined thickness and forming the concave portion 25 in the honeycomb part 21, a notch forming operation (S130) of forming the V-shaped notch 27a on the honeycomb part 21, and a thermal molding operation (S140) of thermally molding the honeycomb part 21 to a predetermined shape.

The honeycomb part machining operation (S110) includes forming the honeycomb part 21 by machining the paper honeycomb P to the predetermined thickness and forming the concave portion 25 in the honeycomb part 21.

The paper honeycomb P, which becomes a basic component of the panel, is machined to a predetermined thickness.

The paper honeycomb P is formed so that the hexagonal pillar structures are continuously formed therein without any gap. A portion of the paper honeycomb P excluding the perimeter becomes the honeycomb part 21 that forms a structure of the panel in the thickness (e.g., vertical) direction.

The paper honeycomb P is machined to the predetermined thickness so that the paper honeycomb P becomes the honeycomb part 21.

The portion of the paper honeycomb P that becomes the honeycomb part 21, for example, the portion excluding the perimeter, is machined to a predetermined thickness through milling. When the paper honeycomb P is milled to become the honeycomb part 21, the paper honeycomb P needs to be face-milled, and thus the paper honeycomb P is milled into the honeycomb part 21 using a face cutter, etc.

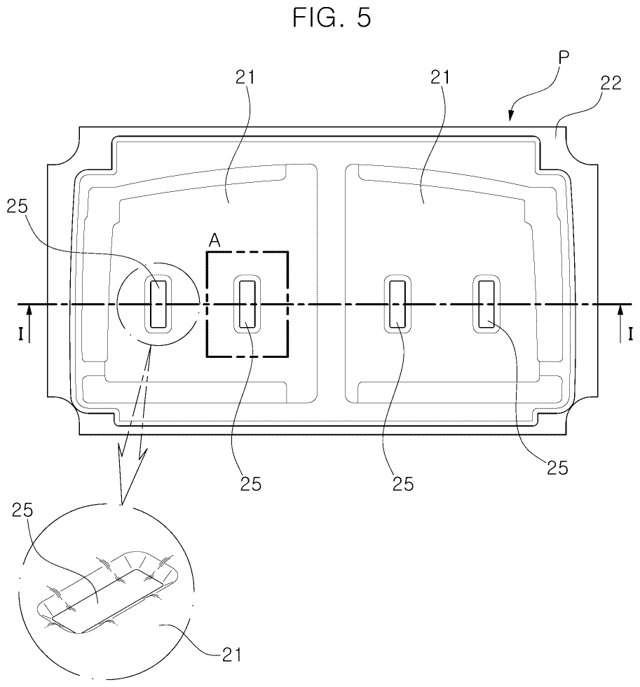

In FIG. 5, the portion of the paper honeycomb P, excluding the perimeter marked by a scrap 22, becomes the honeycomb part 21.

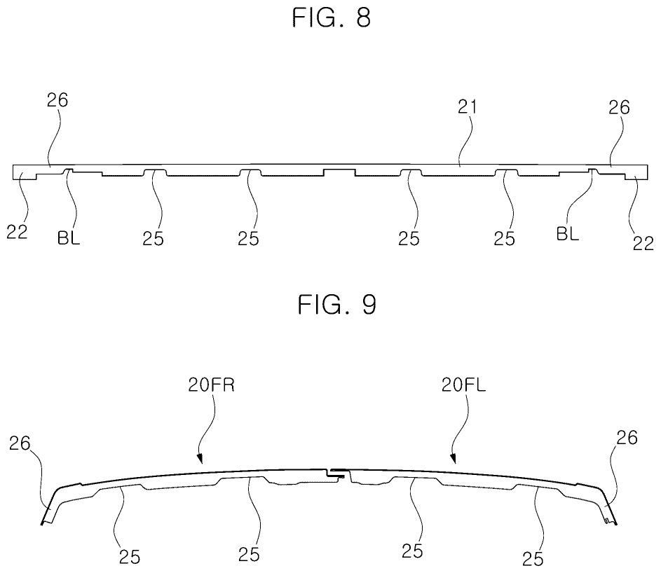

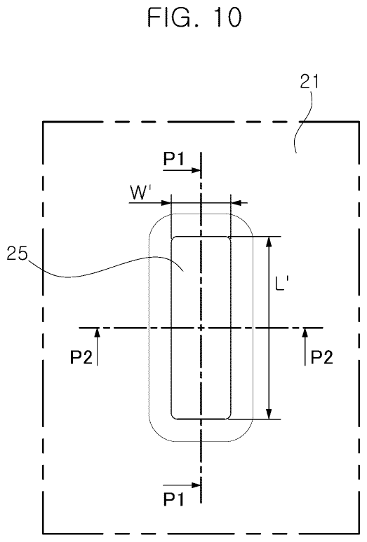

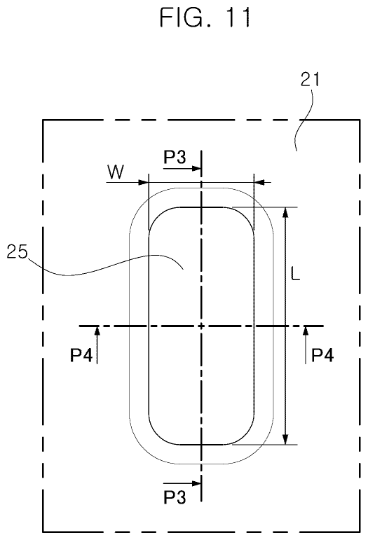

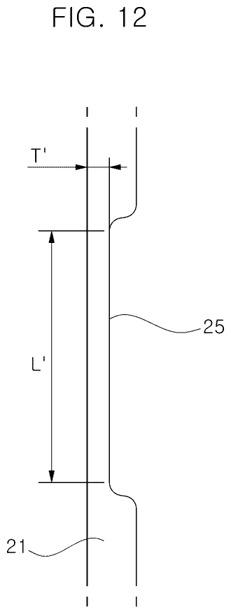

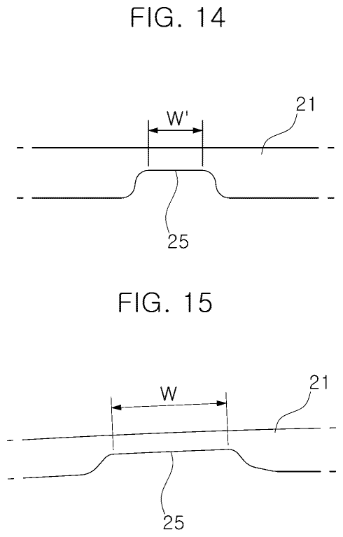

In this case, the concave portion 25 that is concavely formed in the honeycomb part 21 is milled together (e.g., at the same time the paper honeycomb P is milled to the predetermined thickness). As described above, the milled paper honeycomb P has a cross-sectional structure as shown in FIG. 8, and the periphery of the concave portion 25 has a shape as shown in FIG. 10. In a state in which the primary machining is finished as described above, the cross section of the concave portion 25 is as shown in FIGS. 12 and 14.

Here, during the milling, the concave portion 25 is formed to be smaller than the target size. In other words, since the concave portion 25 is formed concavely, the size of the concave portion 25 formed in the honeycomb part machining operation (S110) is formed to be smaller than the target size by performing less machining than would be required to form a concave portion 25 during the milling. The concave portion 25 is machined to the target size through thermal molding in the thermal molding operation (S140) described below.

For example, assuming that the target size of the concave portion 25 is W (width), L (length), and T (depth), the size of the concave portion 25 machined in the honeycomb part machining operation (S110) becomes W′, L′, and T′, and the size of the concave portion 25 becomes W, L, and T through the thermal molding operation (S140) (here, W′<W, L′<L, T′<T). In other words, the concave portion 25 is formed to have W′ (width), L′ (length), and T′ (depth) through the milling and then formed to have W (width), L (length), and T (depth) through subsequent thermal molding.

In particular, in the honeycomb part machining operation (S110), the concave portion 25 is machined to be smaller in a width direction of the vehicle 1 than in a longitudinal direction of the vehicle 1. For example, W′=W−10 mm, L′=L−5 mm, and T′=T−2 mm.

Therefore, in the honeycomb part machining operation (S110), the concave portion 25 has a margin in the width direction of the vehicle that is 1.8 to 2.2 times larger than a margin in the longitudinal direction of the vehicle. The concave portion 25 may have a margin in the width direction of the vehicle that is 2 times larger than a margin in the longitudinal direction of the vehicle. Here, the margin is a difference between the target size of the concave portion 25 and the size of the concave portion 25 machined in the honeycomb part machining operation (S110). The concave portion 25 may have a margin of 5 mm in the longitudinal direction of the vehicle and a margin of 10 mm in the width direction of the vehicle.

The mat fixing operation (S120) includes fixing the mat to each of the upper and lower surfaces of the honeycomb part 21 and bonding the mat to the honeycomb part 21 by applying a resin.

After machining the paper honeycomb P to the predetermined thickness and machining the honeycomb part so that the concave portion 25 is formed in the honeycomb part 21 during the honeycomb part machining operation (S110), the mat made of fiberglass is fixed to each of the upper and lower surfaces of the honeycomb part 21. Resin such as polyurethane is then sprayed onto the fiberglass mat so that the resin is attached to the mat and the upper and lower surfaces of the honeycomb part 21. Thus, the honeycomb part 21 becomes a rigid layer of the panel.

The notch forming operation (S130) includes forming the V-shaped notch 27a so that the edges 26 and 27 are easily formed on the honeycomb part 21.

When the panel is completed, the edges 26 and 27 are formed on the perimeter of the panel in a shape in which the perimeter of the honeycomb part 21 is bent. By forming the edges 26 and 27 on the perimeter of the honeycomb part 21, when the panel is used as the roof panel 20, the panel becomes a side or rear end of the roof panel 20 and is in contact with the body of the vehicle 1.

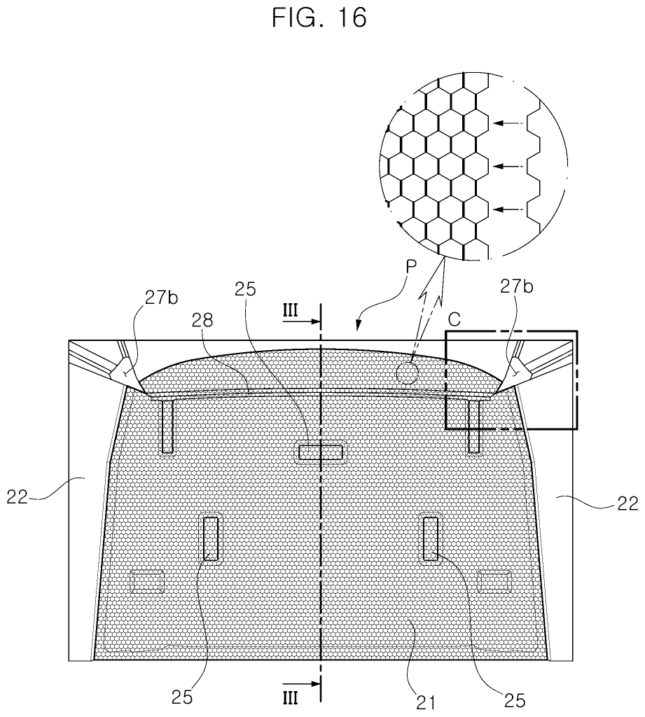

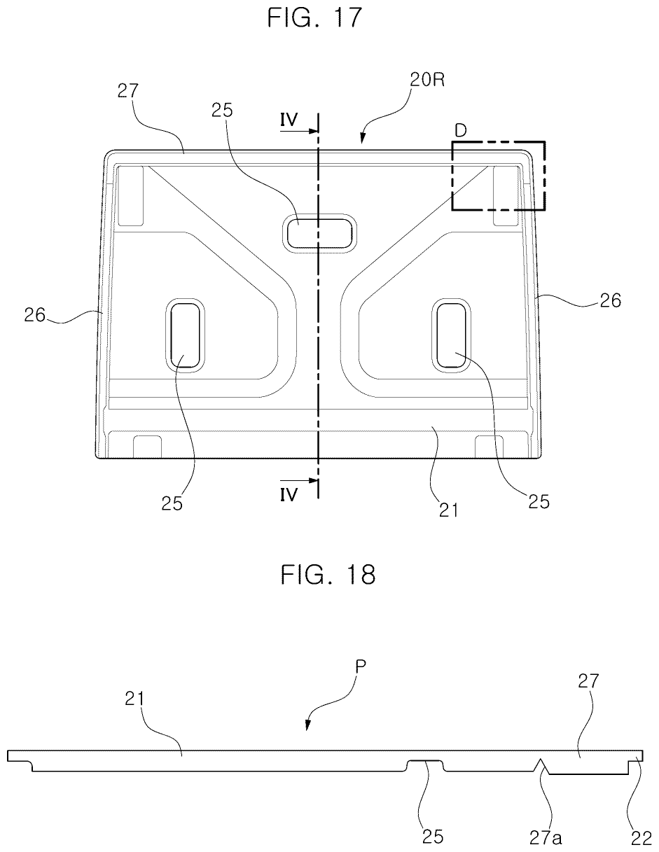

As described above, the edges 26 and 27 become the first edge 26 or the second edge 27. The second edge 27 is formed by bending the honeycomb part 21. The first edge 26 is formed by forming the V-shaped notch 27a whose cross section has a V-shaped groove on the honeycomb part 21 and bending the honeycomb part 21 about the V-shaped notch 27a so that both side surfaces of the V-shaped notch 27a are in contact with each other. Since the paper honeycomb P is completed by bonding pieces of paper, bending about a bonding line is possible, but bending in a direction perpendicular thereto is not possible. The honeycomb part 21 is machined so that the bonding line of the paper honeycomb P is parallel to the longitudinal direction of the vehicle 1. In FIG. 16, the honeycomb part 21 is machined to bond the pieces of paper so that the bonding line is formed in the longitudinal direction (vertical direction in the drawing) of the vehicle 1. In FIG. 16, the paper honeycomb P can be bent in a direction in which left and right sides overlap, but cannot be bent in a direction in which the top and bottom overlap.

Therefore, the bending for forming the second edge 27 is not possible, and only the bending for forming the first edge 26 is possible. Therefore, the V-shaped notch 27a is formed to enable the bending for forming the second edge 27. The V-shaped notch 27a is formed in the same direction as the width direction of the vehicle 1, i.e., in a direction perpendicular to the bonding line of the paper honeycomb P so that bending may be made by the V-shaped notch 27a.

In addition, the notch forming operation (S130) includes forming a triangular notch 27b on a portion where the first edge 26 meets the second edge 27. To form the first edge 26 and the second edge 27, the perimeter of the honeycomb part 21 should be bent, the triangular notch 27b is formed on the portion where the first edge 26 meets the second edge 27. When the triangular notch 27b is not formed, bending is not possible on the portion where the first edge 26 meets the second edge 27, the triangular notch 27b is formed on the honeycomb part 21.

The thermal molding operation (S140) includes thermally molding the honeycomb part 21 to become the shape of the panel.

Since the honeycomb part 21 has a rounded portion excluding the end portions thereof and the first edge 26 and the second edge 27 should be formed on the portion adjacent to the end portion, the honeycomb part 21 undergoing the notch forming operation (S130) is thermally molded.

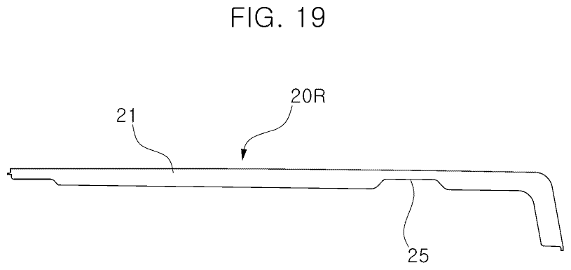

Through the thermal molding operation (S140), the concave portion 25 formed in the honeycomb part 21 to the size smaller than the target size in the honeycomb part machining operation (S110) is molded to the target size. Additionally, through the thermal molding operation (S140), the perimeter of the honeycomb part 21 is bent to become the first edge 26 and the second edge 27. The honeycomb part 21 has a cross section as shown in FIG. 8 and FIG. 18 before thermal molding, and has a cross section as shown in FIG. 9 and FIG. 19 after thermal molding.

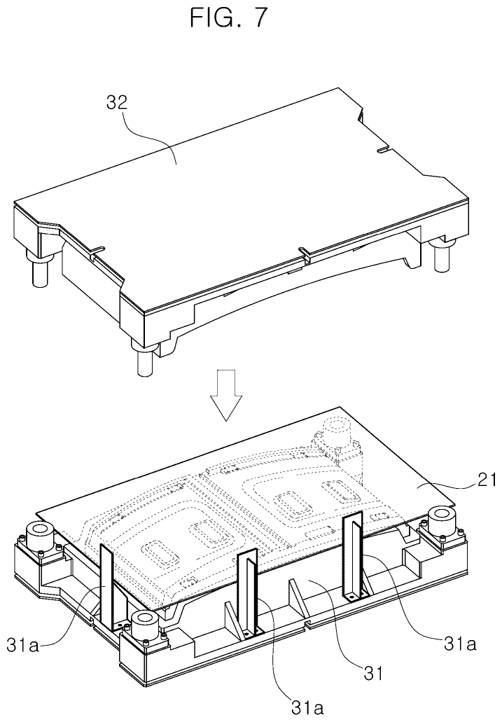

In a state in which the mat has been attached to the upper and lower surfaces of the honeycomb part 21 through the resin, the honeycomb part 21 is thermally molded between a lower thermal mold 31 and an upper thermal mold 32. In other words, as shown in FIG. 7, in a state in which the honeycomb part 21 to which the mat has been attached through the resin is seated on the lower thermal mold 31, the upper thermal mold 32 is moved downward. To easily seat the honeycomb part 21 on the lower thermal mold 31, a guide plate 31a for guiding the seating of the honeycomb part 21 is installed on the perimeter of the lower thermal mold 31, and thus the honeycomb part 21 may be easily seated.

In addition, since the lower thermal mold 31 and the upper thermal mold 32 are in a heated state, the honeycomb part 21 is thermally molded in the shapes of the lower thermal mold 31 and the upper thermal mold 32.

Through thermal molding, the perimeter of the honeycomb part 21 is bent to become the first edge 26 and the second edge 27 while allowing the concave portion 25 to become a final shape.

In this case, since the panel becomes the roof panel of the vehicle 1, the panel has an entirely convex shape in the width direction of the vehicle 1. The perimeter of the panel becomes the first edge 26 and the second edge 27. Since the honeycomb part 21 is thermally molded to the panel by the heated lower thermal mold 31 and upper thermal mold 32, the portion where the V-shaped notch 27a is formed is bonded as the resin bonded to the honeycomb part 21 also fills the V-shaped notch 27a, and the mat is also connected without interruption.

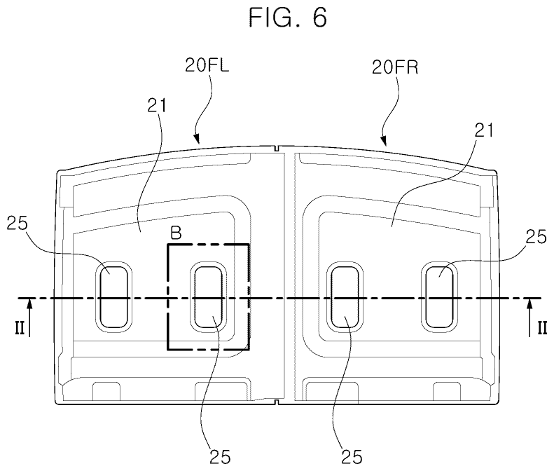

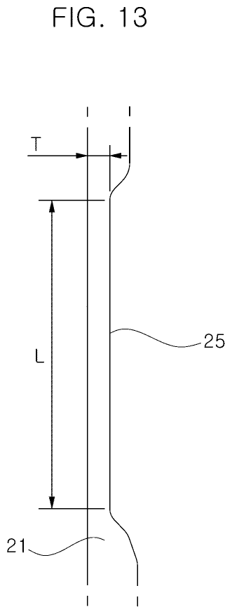

As described above, by the secondary machining through the thermal molding, the concave portion 25 has the target size, that is, W (width), L (length), and T (depth). When the thermal molding is finished, the paper honeycomb P becomes the panel as shown in FIG. 6. The periphery of the concave portion 25 has the same shape as shown in FIG. 11. In a state in which the secondary machining that is thermal molding has been finished, the cross section of the concave portion 25 is as shown in FIGS. 13 and 15.

The trimming operation (S150) includes, after performing the thermal molding operation (S140), removing an unnecessary scrap 22 by cutting the perimeter of the honeycomb part 21.

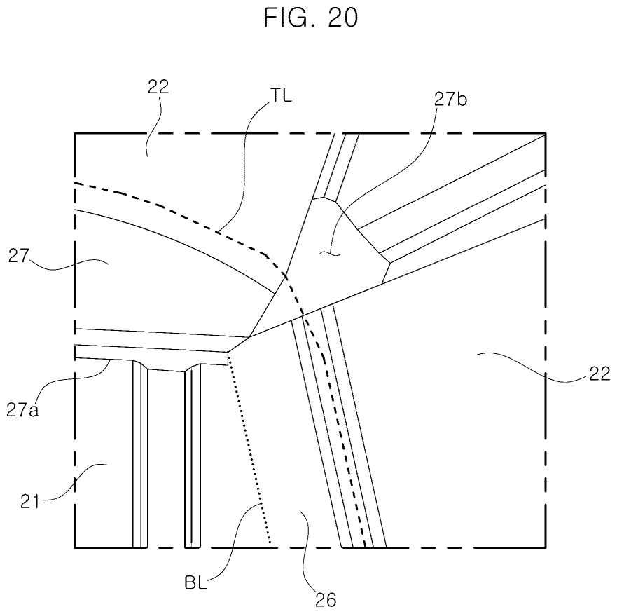

For example, the perimeter of the panel is finished by removing the scrap 22 of the perimeter of the honeycomb part 21 using a water jet nozzle for spraying water at high pressure. The scrap is removed along a trimming line TL shown in FIG. 20.

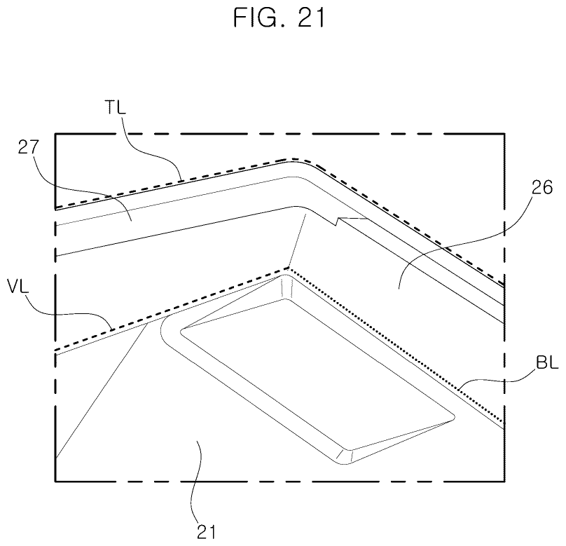

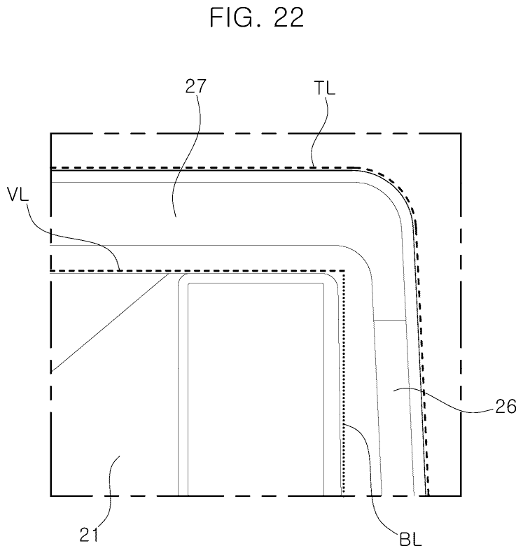

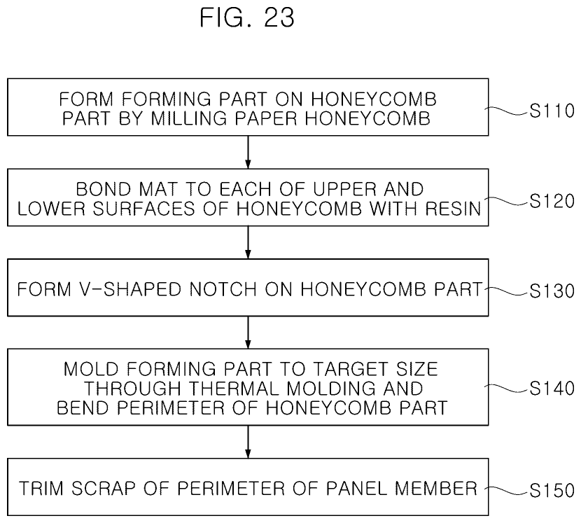

Describing the completed panel, it can be seen that the portion where the first edge 26 meets the second edge 27 is formed continuously without interruption as shown in FIG. 21 and FIG. 22. FIG. 21 and FIG. 22 show the V-shaped notch line VL and the bending line BL where the first edge 26 and the second edge 27 are bent.

The present disclosure has been described with reference to the example embodiments and the drawings, but the present disclosure is not limited thereby. The present disclosure may be carried out in various forms by those having ordinary skill in the art, to which the present disclosure pertains, within the technical spirit of the present disclosure and the scope of equivalents to the appended claims.

What is claimed is:

1. A lightweight panel for a vehicle, comprising:
a honeycomb part including a paper honeycomb whose interior is formed in a honeycomb structure;
a reinforcing layer including a reinforcing mat and a reinforcing resin, and formed on each of upper and lower surfaces of the honeycomb part; and
a plurality of concave portions formed in the lower surface of the honeycomb part.

2. The lightweight panel of claim 1, wherein the plurality of concave portions are formed by milling the paper honeycomb into the honeycomb part and then thermally molding the honeycomb part.

3. The lightweight panel of claim 2, wherein the plurality of concave portions are machined to a size smaller than a target size of the plurality of concave portions during milling, and
wherein the plurality of concave portions are molded to the target size during thermal molding.

4. The lightweight panel of claim 3, wherein the plurality of concave portions are machined to be smaller in a width direction of the vehicle than in a longitudinal direction of the vehicle during the milling.

5. The lightweight panel of claim 4, wherein the size of the plurality of concave portions machined in the milling and the target size of the plurality of concave portions are machined to have a difference in size in the width direction of the vehicle that is 1.8 to 2.2 times larger than a difference in size in the longitudinal direction of the vehicle.

6. The lightweight panel of claim 1, wherein the panel has an edge formed by being bent in a longitudinal direction or width direction of the vehicle along a perimeter of the honeycomb part.

7. The lightweight panel of claim 6, wherein the edge includes:
a first edge bent in the longitudinal direction of the vehicle with respect to the width direction of the vehicle; and
a second edge bent in the width direction of the vehicle with respect to the longitudinal direction of the vehicle.

8. The lightweight panel of claim 7, wherein one edge of the first edge and the second edge is formed by forming a V-shaped notch whose cross section is formed in a V shape on the paper honeycomb and bonding the paper honeycomb along the V-shaped notch during thermal molding.

9. The lightweight panel of claim 7, wherein an other edge of the first edge and the second edge is formed by bending the panel during thermal molding that machines the concave portions to the target size.

10. The lightweight panel of claim 7, wherein a triangular notch is formed on a portion of the honeycomb part where the first and second edges are folded, and
the first and second edges are in contact with each other by being bent at the triangular notch.

11. A method of manufacturing a lightweight panel for a vehicle, where the lightweight panel includes a honeycomb part having a paper honeycomb whose interior is formed in a honeycomb structure, and a reinforcing layer including a reinforcing mat and a reinforcing resin, formed on each of upper and lower surfaces of the honeycomb part, the method comprising:
forming a honeycomb part by machining the paper honeycomb to a predetermined thickness and forming a concave portion in the honeycomb part, during a honeycomb machining operation;
forming a V-shaped notch on the honeycomb part, during a notch forming operation; and
thermally molding the honeycomb part to a predetermined shape, during a thermal molding operation.

12. The method of claim 11, wherein, in the honeycomb machining operation, the concave portion is machined to a size smaller than a target size of the concave portion, and
the concave portion is molded to the target size in the thermal molding operation.

13. The method of claim 12, wherein, in the honeycomb machining operation, the concave portion is machined to be smaller in a width direction of the vehicle than in a longitudinal direction of the vehicle.

14. The method of claim 11, wherein the size of the concave portion machined in the honeycomb machining operation and the target size of the concave portion have a difference in the width direction of the vehicle that is 1.8 to 2.2 times larger than a difference in the longitudinal direction of the vehicle.

15. The method of claim 11, wherein, in the notch forming operation, the V-shaped notch is formed in a direction perpendicular to a bonding line of the paper honeycomb, which bonds pieces of paper with unevenness.

16. The method of claim 15, wherein, in the thermal molding operation, the honeycomb part forms a second edge by being bent about the V-shaped notch.

17. The method of claim 16, wherein, in the thermal molding operation, the honeycomb part forms a first edge by being bent in a direction perpendicular to a direction in which the V-shaped notch is formed.

18. The method of claim 17, wherein the notch forming operation includes forming a triangular notch on a portion where the first edge meets the second edge.

19. The method of claim 11, further comprising a mat fixing operation between the honeycomb machining operation and the notch forming operation, the mat fixing operation including fixing a mat to each of upper and lower surfaces of the honeycomb part and bonding the mat to the honeycomb part by applying a resin to the mat and the honeycomb part.

20. The method of claim 11, further comprising a trimming operation of cutting an unnecessary scrap of a perimeter of the honeycomb part after the thermal molding operation.
